(19) United States
(12) Patent Application Publication
(10) Pub. No.: US 2008/0095425 A1
(43) Pub. Date: Apr. 24, 2008

(54) Digitized bank checks validated by digital signatures

(75) Inventors: Gene R. Franklin, Waterloo (CA); David G. Schwartz, Waterloo (CA); Peter Hendsbee, Brantford (CA); Vinay Moharir, Mumbai (IN); N. Balakrishnan, Dobi Alloy (IN)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 11/585,626

(22) Filed: Oct. 24, 2006

(51) Int. Cl. G06K 9/00; H04N 5/76

(52) U.S. Cl. 382/137; 348/231.2

(57) ABSTRACT

A modified multi-page TIFF file. A Tagged Image Format File (TIFF) conforms to a published standard. The TIFF file contains an initial header, which contains a pointer to another header, which points both to (1) the first graphical image and (2) a second header. The second header points to both (1) the second image and (2) a third header, and so on. The headers allow a TIFF reader to locate any selected graphic image, and display it. The invention interleaves auxiliary information within the TIFF file, for example, between a header and a graphical image. The auxiliary information does not interfere with the TIFF reader, and the TIFF reader does not detect the auxiliary information.

The invention concerns computer files which contain multiple visual images, such as multi-page TIFF files. TIFF is an acronym for Tagged Image Format File. Under the invention, additional data is added to the multi-page TIFF file. The additional information does not interfere with a TIFF reader, which displays the visual images. Another type of reader is used to display the additional information.

The invention can be used in a check-clearing process of a banking system, wherein paper checks are replaced by digitized versions of the paper checks. Commonly, the digitized versions are maintained in a secure central location, and copies of the digitized versions are sent to the banks upon which the checks are drawn. Additional information, such as a bank statement, can be included in the file containing images of the checks.

### BACKGROUND OF THE INVENTION

In transactions, people frequently make payment using bank checks. The recipients of the bank checks deposit the checks in accounts in banks. The banks then transmit the deposited checks to a central clearing station, which is commonly managed by a division of the national government.

FIG. 1 illustrates a stack 3 of paper bank checks which represents checks collected at the clearing station. One check 6 is shown in detail. The clearing station undertakes a check-clearing process, wherein accounting is done to settle accounts among the banks involved with the checks. The clearing station then distributes the checks to the banks on which they were drawn.

Recently, with the advent of inexpensive, high-speed digital computation, and because of various governmental regulations, a movement has originated to eliminate the distribution of the paper bank checks. To replace the paper checks, digitized images of the checks are generated using optical scanners, and the digitized images are distributed electronically to the banks which would otherwise receive the paper checks. The paper checks 3 in FIG. 1 can be held in long-term storage, in case they are needed, or can be disposed.

FIGS. 2-5 illustrate conceptually the digitizing process. Each check 6 is divided into pixels 9, as in FIG. 2. FIG. 2 is a simplification: the number of pixels actually used is much larger than that indicated by the Figure.

Each pixel is assigned a value, or number, which indicates optical properties of the pixel. For example, if grey-scale photography is used, then the number indicates the relative grayness of the pixel, on a scale ranging from pure white to pure black. FIG. 3 provides an illustration, and shows three pixels 9. If a pixel is pure black, and if one byte is associated with each pixel, then the pixel is assigned the number 255. If a pixel is pure white, it is assigned the number zero. If a pixel is grey, it is assigned a number between 1 and 254, depending on the degree of grayness.

The numbers assigned to the pixels are arranged in a convenient sequence, such as that suggested by FIG. 4. The top row of pixels is assigned positions 1 through 37 in the sequence. The second row is assigned positions 38 through 74, and so on.

Thus, each bank check is, in effect, converted to a sequence of numbers, such as the sequence shown in FIG. 5, wherein B(1) refers to the first byte in the sequence, and represents the grey-scale value of pixel number 1 in FIG. 4. Byte B(2) in FIG. 5 represents the value of pixel number 2 in FIG. 4, and so on. The sequence is shown as terminating in B(10,000) because ten thousand is considered a good estimate of the total number of pixels currently used to digitize a bank check.

The sequence of numbers of FIG. 5 will be termed the “image-data” of the check.

Once the image-data is generated, copies of the original check can be reproduced from the image-data. The copies can be displayed on a computer screen, printed on paper, or both, using known methods.

However, in order to produce accurate copies, certain technical information must be known about the original image-data. For example, the actual size of each pixel 9 in FIG. 2 must be known, to create a copy of the same size as the original.

As a second example, the length and width of the image, in pixels or equivalent, must be known. As a third example, it must be known whether the pixels represent color-values (not discussed herein), grey scales, or other representations. As a fourth example, it must be known whether the image-data is compressed and, if so, what compression algorithm was used.

This technical information, and other technical information, is generally attached to the image-data. Various file formats have been developed which package the two groups of data together, namely, (1) the image-data and (2) the technical information.

One file format which has achieved widespread usage is the Tagged Image File Format, or TIFF. The TIFF format is defined in a specification which is publicly available from Adobe Systems, San Jose, Calif., USA, and, in April, 2006, was available on-line at http://partners.adobe.com/asn/developer/PDFS/TN/TIFF6.pdf.

Some banking systems have adopted the TIFF format for storage of the digitized images of their bank checks. In addition, some of these banking systems store, for example, four images of each check within a single TIFF file. A first image corresponds to the front of the check, and a second image corresponds to the back of the check, as it initially arrives for processing. Later, during the check-clearing process, additional information can be added to the check, such as routing information. Two additional images, front and back, are created of the check after modification, thereby explaining the total of four images.

The TIFF convention, or standard, allows these multiple digital images to be stored in a single data file. The use of a single file, as opposed to four separate files, provides convenience of handling, since only a single file must be named and tracked, as opposed to four files.

The Inventors have identified potential problems in this single-file approach to storage of multiple images, and have developed stratagems which reduces the problems. The Inventors have also developed an improved file structure for multi-image files.

### OBJECTS OF THE INVENTION

An object of the invention is to provide an improved check-clearing system for banks.

A further object is to provide a system for authenticating copies of digital images of bank checks.

A further object is to provide an improved file structure for multi-image files.

### SUMMARY OF THE INVENTION

In one form of the invention, additional information is interleaved within a TIFF file which contains multiple visual images, or other multi-image file. A standard viewing program for the file ignores the additional information, and displays the images in the usual manner. Other software, independent of the viewer, can use the additional information for other purposes.

### BRIEF DESCRIPTION OF THE DRAWINGS

FIG. 1 illustrates a stack 3 of bank checks.

FIG. 2 illustrates pixels 9.

FIG. 3 illustrates different numerical values assigned to three different pixels 9.

FIG. 4 illustrates one type of sequence in which pixels can be arranged.

FIG. 5 illustrates a sequence of bytes, each corresponding to a pixel.

FIG. 6 illustrates in simplified form the creation of a digital signature for a file.

FIG. 7 illustrates contents of an exemplary graphics file.

FIG. 8 illustrates contents of an exemplary graphics file, which contains four files of the type shown in FIG. 7.

FIG. 9 illustrates differences between (1) the file of FIG. 8 and (2) the original of one of the files contained in the file of FIG. 8.

FIG. 10 illustrates the differences of FIG. 9, in a different way.

FIG. 11 illustrates a table, showing data which has changed when a file is added to the composite file of FIG. 9, and also the original data.

FIG. 12 illustrates one form of the invention.

FIG. 13 is a simplified view of content of FIG. 8.

FIG. 14 illustrates one form of the invention.

FIG. 15 illustrates another form of the invention.

FIGS. 16, 17, and 18 are flow charts illustrating processes undertaken by one form of the invention.

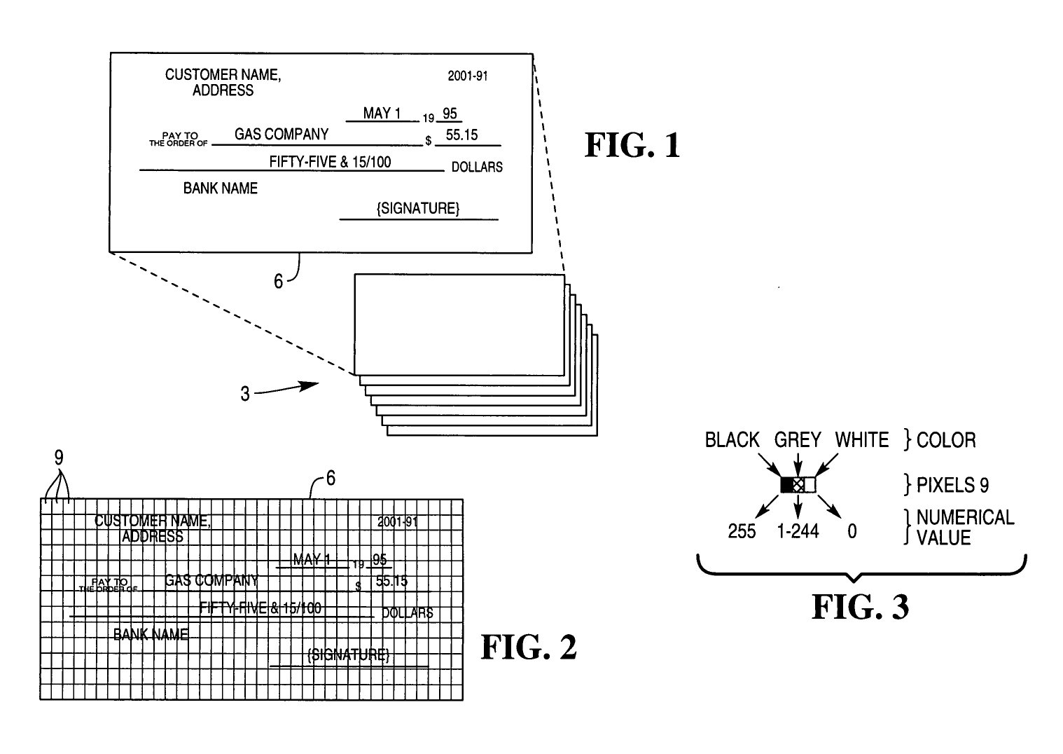

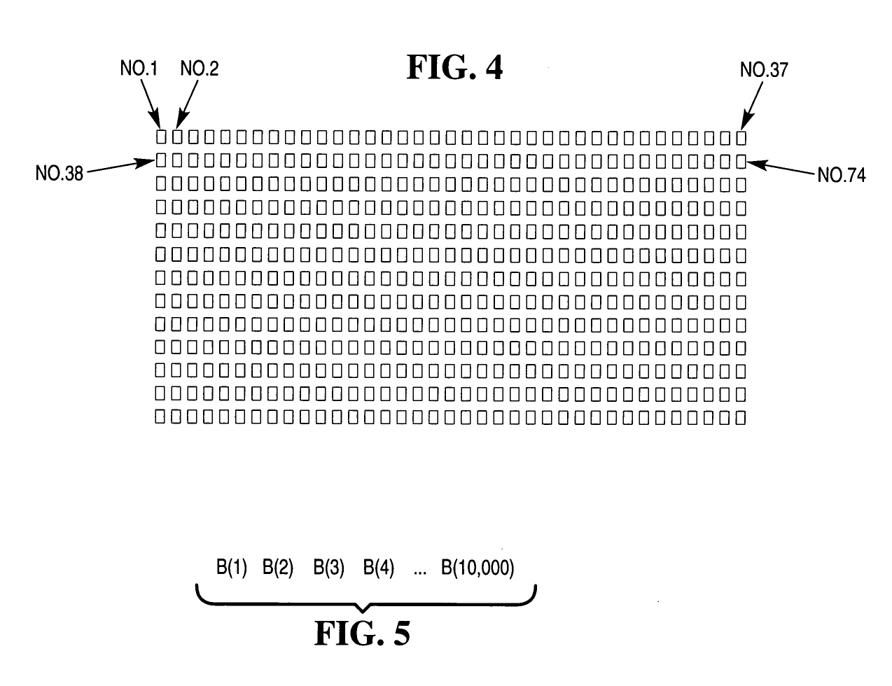

### DETAILED DESCRIPTION OF THE INVENTION

In general, a bank customer can request a paper copy of a cancelled check. If digitized images of the cancelled checks were returned to the customer's bank, as described in the Background of the Invention, then bank locates the digitized image of the requested check, and prints a copy onto paper for the customer, instead of retrieving the actual, physical, cancelled check.

The Inventors have observed that a question can arise as to whether the digitized image which the bank retrieves is an accurate copy of the digitized image initially created when the check underwent the clearing process. One resolution to this question can be achieved by adding a digital signature to the original digitized image. Some basic principles of digital signatures will be explained, to explain how digital signatures can verify authenticity of a copy of the original digitized image.

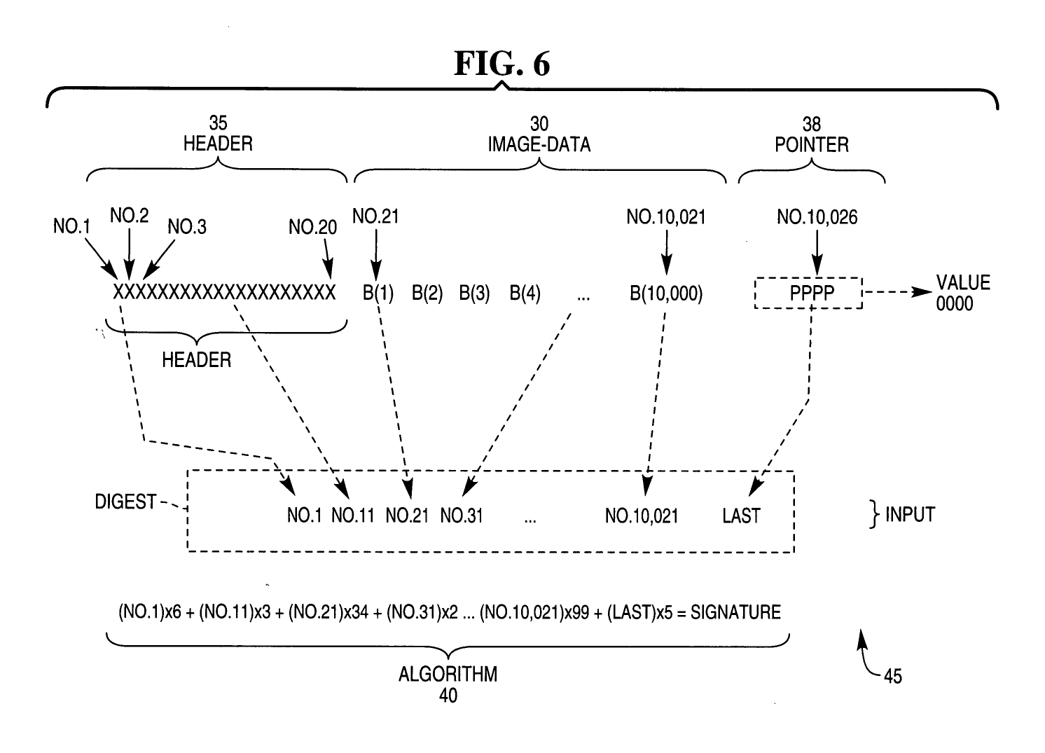

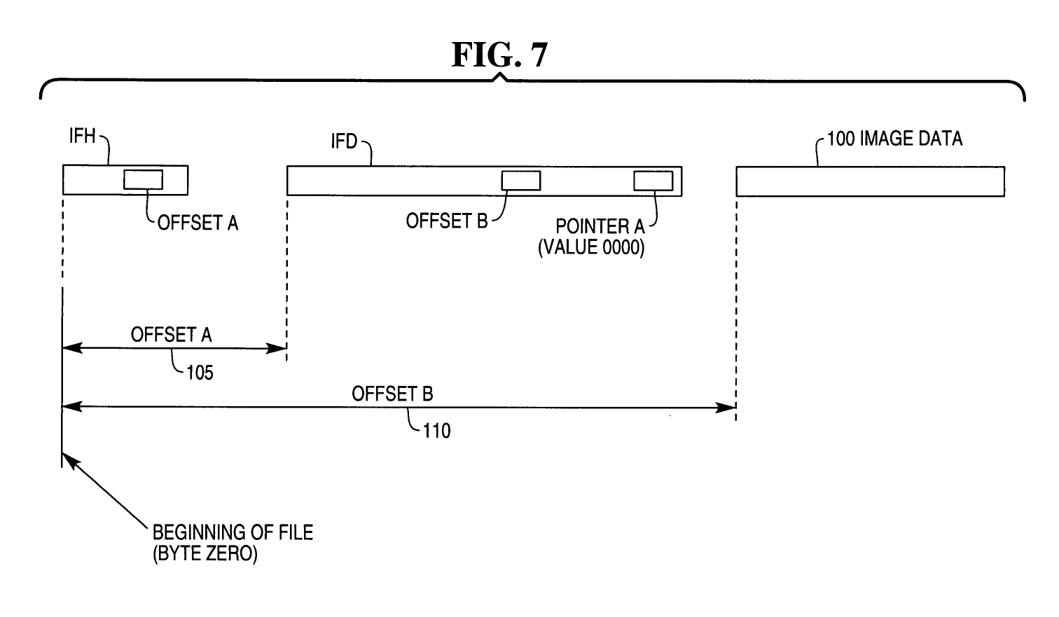

FIG. 6 represents a generalized graphics file, which may include

(1) image-data 30 of a check, indicated as bytes B, which begin with byte B(1) numbered 21;

(2) a header 35 which includes other information, such as the technical information discussed above, and represented by bytes X; and

(3) a pointer 38, containing bytes P, which may point to data which relates to another image of the check, within the same file.

All bytes B, X, and P can be treated as numbers, for purposes of the digital signature, even though the bytes may, in fact, represent other information, such as alphabetical characters.

To generate a digital signature, one first selects a subset of the numbers, or bytes, in the file. (One could use all numbers in the file, and the concept of a digital signature does not preclude usage of all the numbers. However, the Inventors point out that trade-offs are involved here. On the one hand, usage of all numbers in the file may require greater computation time. On the other hand, a computer program which develops a signature from all the numbers may be easier to generate. Further, even if usage of all numbers imposes certain difficulties, the difficulties may be justified by the fact that the file is extremely valuable, and the use of all numbers can provide greater protection.)

This selected subset is called the “digest” of the file. A formula determines how the digest is selected. As a simple example, the formula may specify that (1) the first byte, (2) every tenth byte thereafter, and (3) the final byte are used. This particular selection of bytes is indicated in FIG. 6, adjacent the word “INPUT.”

In some approaches, the subset is further processed, in order to produce a digest of a specific length, such as 128 bytes. One reason is that the algorithm, described below, requires input of that specific length.

The digest is then applied as input to a selected algorithm 40 in FIG. 6. The algorithm shown is a simple polynomial equation, for ease of illustration. Actual algorithms used in practice can be much more complex. The algorithm 40 produces an output, which is the signature 45, and is a number. This signature/number is then associated with the file, and is the “digital signature.”

To determine whether a copy of the original file is identical to the file itself, one repeats the process just described, but upon the copy, rather than the original file itself. That is, one extracts a digest from the copy, and applies the digest as input to the same algorithm.

If the same signature is obtained, then it is known, with an extremely high degree of probability, that the copy is an accurate rendition of the file. If the same signature is not obtained, it may safely be assumed that the copy is not accurate.

The Inventors have discovered problems when this approach is applied to files containing multiple digitized images. The problems will be explained by reference to FIGS. 7-9.

FIG. 7 is a simplified rendition of content of a TIFF file for a single bank check. Block 100 represents the image-data, which holds the byte-sequence derived from the bank check, and corresponds to the byte sequence shown in FIG. 5.

The TIFF file also contains two headers. One header, the Image File header, IFH, includes (1) a pointer, labeled OFFSET A, and (2) other technical data, not shown. The pointer OFFSET A points to another header, the IFD, Image Format Directory, by specifying the offset of the latter header IFD from the beginning of the file, in number of bytes. The offset is indicated by distance 105. The header IFD contains the technical information (check dimensions, type of compression, etc.) discussed above.

The pointer OFFSET A is needed because, under the TIFF convention, the header IFD need not be located immediately subsequent to the previous header IFH.

Another pointer is present, POINTER A, and is located in the IFD header. This pointer serves two functions. One function is a result of the fact that the TIFF file may contain multiple image-data 100, as explained above. In such a case, each collection of image-data 100 is assigned its own IFD header. For example, in the check-system under discussion, a single TIFF file will contain four digitized images of a check. The TIFF convention requires one header IFD header for each digitized image, for a total of four IFDs.

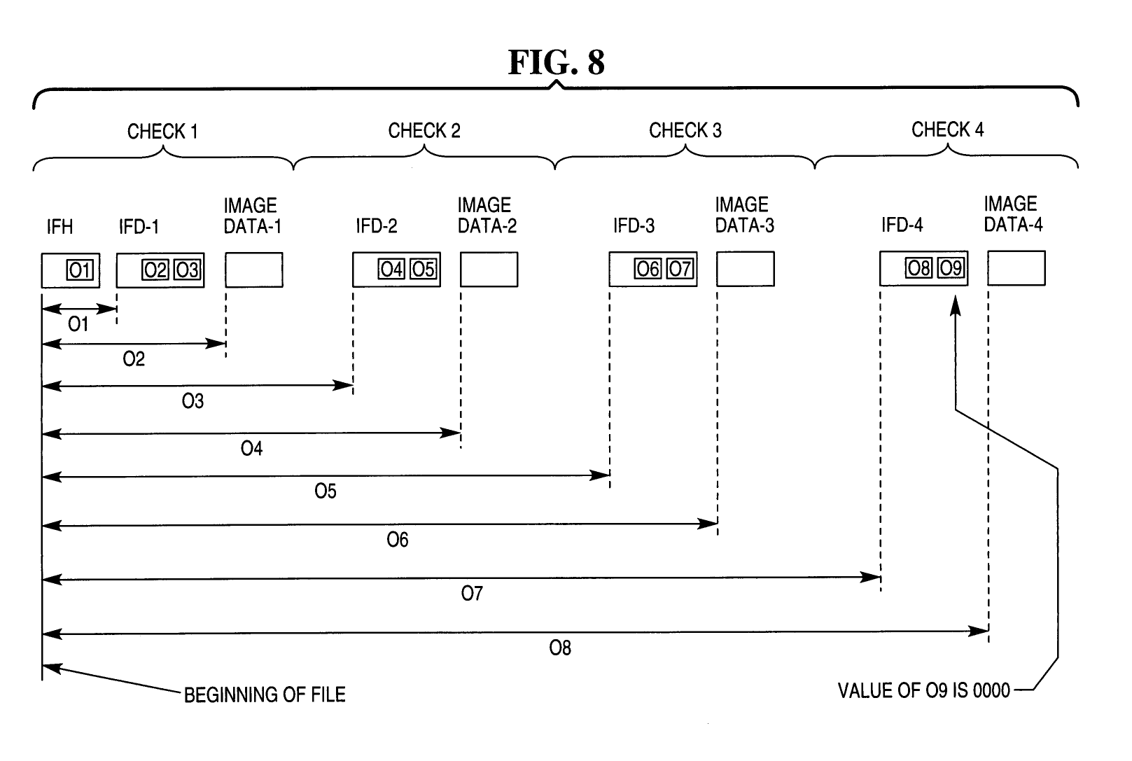

In such a case, shown in FIG. 8, POINTERs A (indicated as OFFSETs O3, O5, and O7) are used to point to the next headers of type IFD.

However, in FIG. 7, the TIFF file contains a single digitized image, and not multiple digitized images. Thus, a single IFD is present. Consequently, POINTER A is set to 0000, because no subsequent IFD is present. Similarly, OFFSET O9 in FIG. 8 has a value of 0000, indicating that no subsequent IFD is present.

These values of 0000 indicate the second function served by POINTER A. That second function is to indicate that no further headers IFD are present. Thus, POINTER A either (1) points to the next IFD or (2) indicates that no further IFDs are present.

Header IFD in FIG. 7 also contains another pointer, OFFSET B, which indicates the beginning of the image data 100, measured from the beginning of the file. Distance 110 indicates OFFSET B.

A digital signature can be taken of the file of FIG. 7, in the manner of FIG. 6, and used to verify authenticity of copies.

However, if the single file in FIG. 7 is combined with other single files into a single TIFF file, and if the TIFF convention is followed, the digital signature of the original single file can be rendered non-usable, as will now be explained.

FIG. 8 illustrates digital images of four checks, packaged into a single file. (It does not represent the four images of a single check, discussed above, but the principles discussed apply to those four images.) A single IFH is present, and may, or may not, be viewed as part of CHECK 1, for reasons which will become clear.

Each check is assigned image data: IMAGE DATA-1, IMAGE DATA-2, etc. Each check is also assigned an IFD, Image File Directory, for its block of image-data. The IFDs contains the technical information discussed above.

Pointers are present, labeled O1 (offset 1), O2 (offset 2), and so on. Offsets O3, O5, O7, and O9 correspond in function to POINTER A in FIG. 7. Each points to the beginning of the next IFD, with the exception of offset 9, which has a value of 0000, as indicated. The value of 0000 indicates that no further IFD's follow.

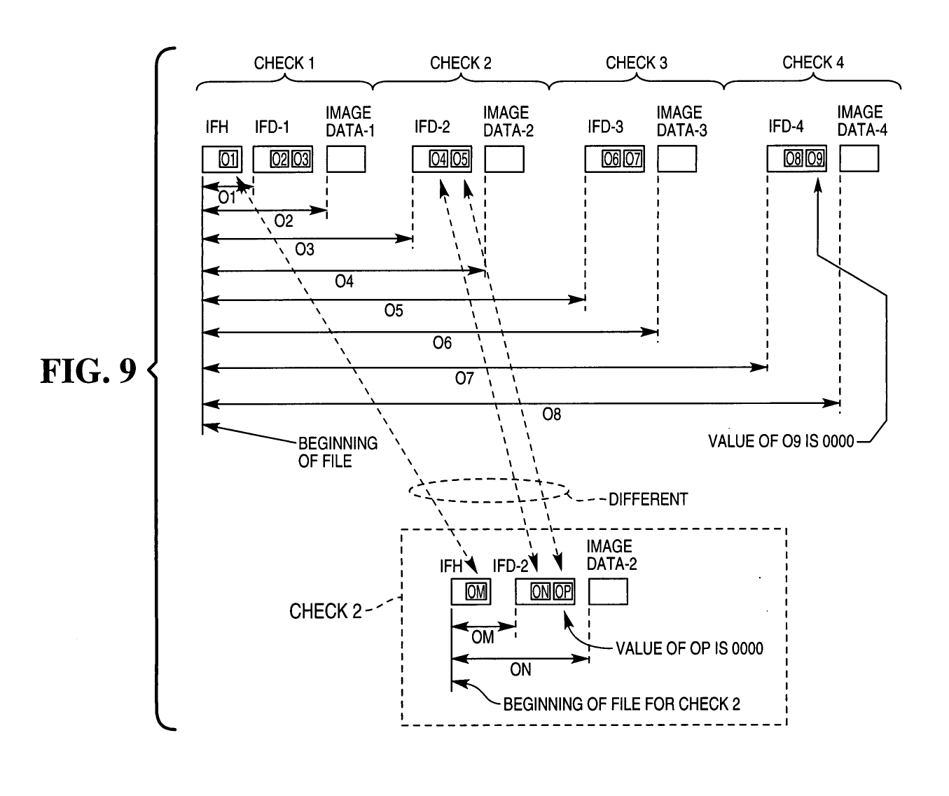

FIG. 9 illustrates how the original TIFF file for CHECK 2 differs from the corresponding file for CHECK 2, when combined with three other TIFF files, as in FIG. 8.

FIG. 9 shows original CHECK 2 at the bottom of the Figure. Original CHECK 2, by itself and prior to insertion into the larger file shown in FIG. 9, contains an offset OM, which points to IFD-2. (OFFSET OM corresponds in function to OFFSET A in FIG. 7.) However, in the multiple TIFF file, the corresponding offset O1 will be different, because offset O1 points to IFD-1, which is associated with CHECK 1, not CHECK 2.

That is, in concept, the single header IFH in FIG. 9 is used for all four check-files. Plainly, OFFSET O1, contained in that header, does not point to IFD-2 for CHECK 2. (It may occur that OFFSET 01 has the same numerical value as OFFSET OM, because, in FIG. 9, IFD-1 may be adjacent to IFH in the composite file, and also IFD in CHECK 2 may be adjacent to IFH. However, that would be coincidence, and cannot be relied upon.)

Therefore, the value OM in original CHECK 2 has probably been changed to the value of O1 in the composite check which contains three other checks, as indicated by the dashed double-arrow pointing to those two offsets.

Similarly, offset ON in CHECK 2 will be different from corresponding offset O4.

Also, offset OP in CHECK 2 will be different from corresponding offset O5.

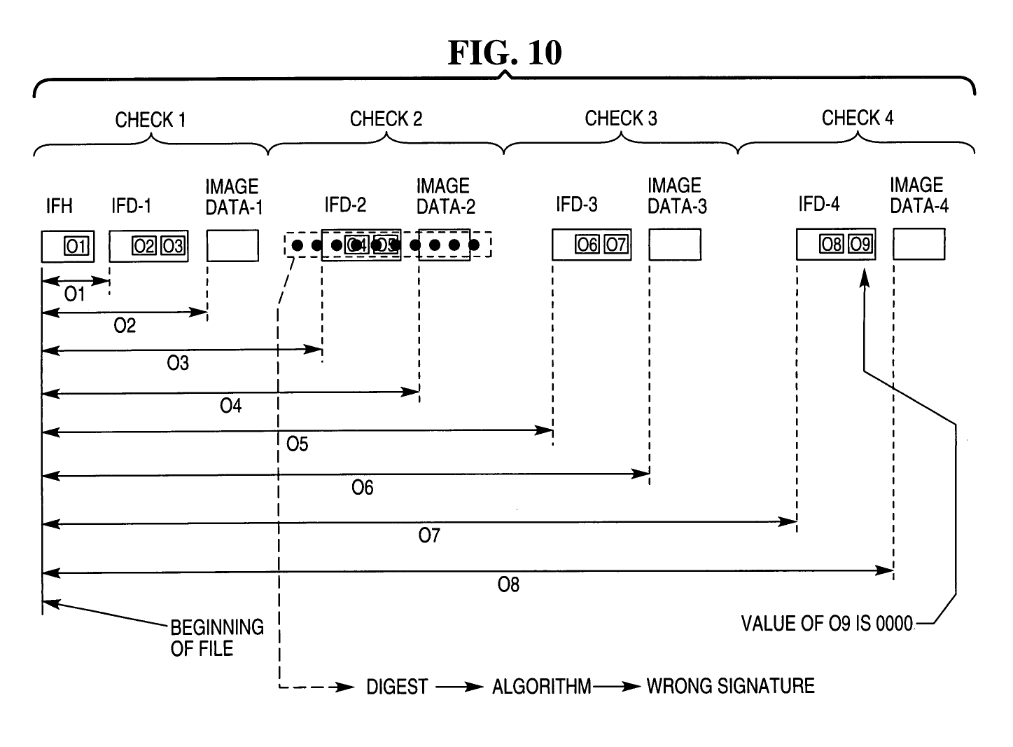

Therefore, assume that a formula is used to take a digest from CHECK 2, as stored within the composite file in FIG. 10. The dots indicate bytes collected from the data corresponding to CHECK 2, and collectively represent the digest. That digest, when input to the algorithm, will produce a given digital signature. That digital signature will be different from that obtained from the original file for CHECK 2, prior to insertion into the composite file of FIG. 9. One reason lies in the differences in offsets just discussed.

Thus, a problem arises in attempting to use digital signatures to validate a copy of a digitized check, when taken from a composite image file containing several checks.

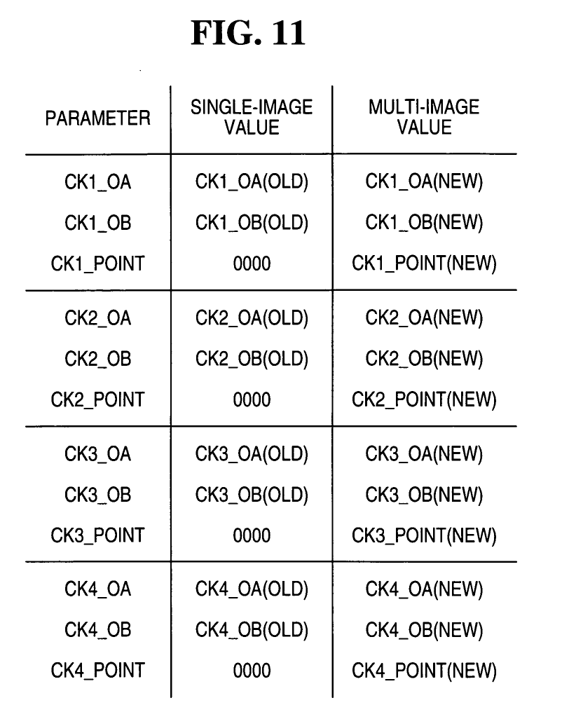

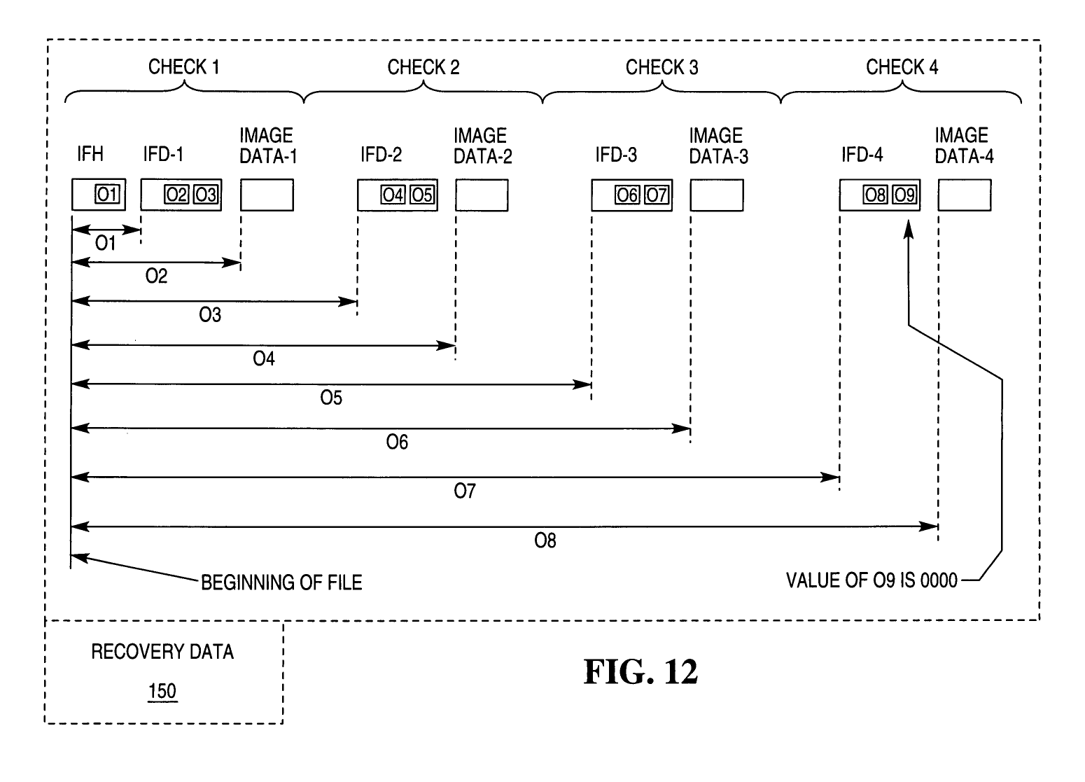

One stratagem for mitigating or eliminating this problem is shown in FIGS. 11 and 12. FIG. 11 is a table. In the left column, the terms CK1, CK2, etc. refer to check 1, check 2, etc.

In the same left column, the terms OA, OB, and POINT, refer to OFFSET A, OFFSET B, and POINTER A in FIG. 7. Thus, for example, the term “CK1-OA” refers to OFFSET A in check 1. FIG. 7 shows this OFFSET A in a generalized check. The term “CK1-OB” in FIG. 11 refers to OFFSET B in check 1. FIG. 7 shows this OFFSET B in a generalized check. And so on in FIG. 11.

In the central column of FIG. 11, “old” or original values of the parameters labeled in the left column are indicated. These old values refer to the values in the original, separate TIFF files, each of which corresponds to a single digitized check-image. FIG. 7 represents one such file.

That is, when one of the four digitized images of a check is initially created, one of the four triplets in the center of FIG. 11 will be contained in that digitized image. (Of course, FIG. 11 is a simplification of the TIFF convention: the data in question need not contain triplets.)

The right column in FIG. 11 indicates the new values of the parameters, as stored in the multiple file, as in FIG. 8. In general, the new values will be different from the old values.

One exception lies in the POINTER A of FIG. 7. In a single, separate file, the POINTER A will have a value of 0000, as discussed above, indicating that no further IFDs follow. However, in the last file within the composite file of FIG. 8, which is that for CHECK 4, the corresponding POINTER A (i.e., OFFSET 9, or O9) also has a value of 0000.

Thus, the single check which is placed in the last position within the composite file of FIG. 9 will keep its value of 0000 for the pointer corresponding to POINTER A in FIG. 7. More specifically, in this example, in FIG. 11, the parameter CK4-POINT will have a value of 0000 in both the separate file and the composite file.

From another perspective, the central column of FIG. 11 illustrates certain data for each individual TIFF image, the data being of the type shown in FIG. 7. The right column of FIG. 11 illustrates corresponding data, but for the composite file shown in FIG. 8.

In one form of the invention, sufficient data is associated with the data of FIG. 8, to allow recovery of the central column of FIG. 11. This data is indicated as recovery data 150 in FIG. 12. This data may be embedded in the composite TIFF file, attached to the TIFF file, or stored in another file, which is linked or otherwise associated with the composite TIFF file.

The invention specifically contemplates a file format which contains separable sub-files. For example, a TIFF file can be concatenated with another file, such as the recovery data 150 of FIG. 12. An internal end-of-file marker, I-EOF separates the two files. Thus, an ordinary TIFF reader knows that the TIFF file ends at the I-EOF, and ignores data following the I-EOF.

However, another processing program knows that data of interest to it lies beyond the I-EOF, and locates the data based on the I-EOF. For example, a digital signature recovery program would locate the table of FIG. 11, or subset thereof, after the I-EOF, and use it to re-construct an original TIFF file.

One form of the invention lies in the process encompassing the following steps.

1. Generating multiple digitized images for each bank check processed in a check-clearing process.

2. Packaging each digital image into an individual graphics file.

3. Deriving a digital signature for each graphics file.

4. Modifying parts of the graphics files, in order to package the graphics files into a single, composite file containing multiple digitized images.

5. Storing data indicating the modifications, so that the individual graphics files can be recovered from the composite file and produce the correct digital signatures.

### ADDITIONAL EMBODIMENT

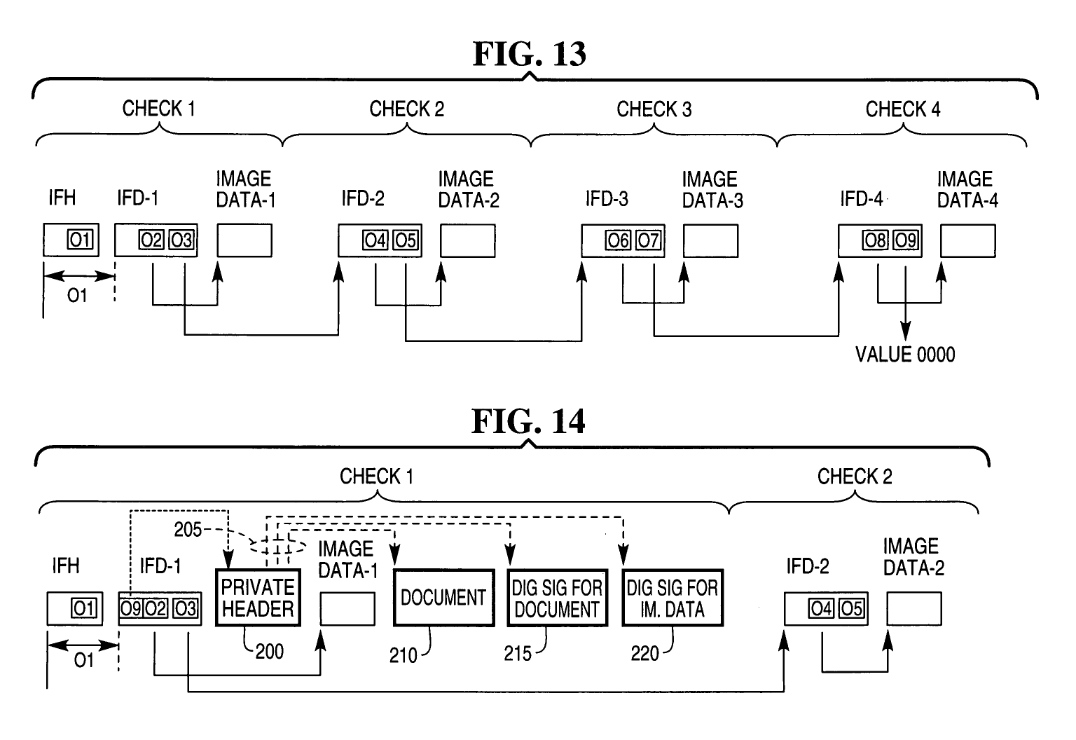

FIG. 13 is an alternative rendition of FIG. 8, showing how the pointers such as O2, O3, etc., point to the locations of various data blocks contained within the file. For example, pointer O3 points to the beginning of IFD-2.

In another form of the invention, additional data can be interleaved within the data blocks of FIG. 13, as indicated in FIG. 14. The four blocks 200, 210, 215, and 220 drawn in heavy outline represent the added data.

Block 200 represents a private header which is inserted between IFD-1 and IMAGE DATA-1. The private header 200 contains pointers, indicated by the dashed arrows 205, which point to the three other added blocks 210, 215, and 220. Three other blocks are shown, but a greater or lesser number may be used, depending on the needs of the designer.

Block 210 represents a document which is inserted. The document 210 may contain content which is conceptually associated with the TIFF image stored in IMAGE DATA-1. For example, the document 210 may take the form of a monthly checking account statement. The TIFF image in IMAGE DATA-1 may contain a cancelled bank check related to the same bank account. In this example, an overall goal is to consolidate all bank records relating to the specific account, or to a specific person, in a single file, which is represented in FIG. 14.

As another example, the document 210 may be the original TIFF image of the cancelled check represented by the TIFF image contained in IMAGE DATA-1. As explained above, in general, the original TIFF image of block 210 will contain different pointers than will IMAGE DATA-1, because IMAGE DATA-1 is incorporated into a multi-image TIFF file, which required an alteration of the pointers. Consequently, the original TIFF image of block 210 will produce a different digital signature than will IMAGE DATA-1.

However, if the document 210 contains the original TIFF image, then that original TIFF image can be recovered, by simply reading block 210. The difference structure of FIGS. 11 and 12 is not required for recovery of the original TIFF file.

Therefore, as so far explained, this additional embodiment provides two features. One, an ordinary TIFF reader can be used to read the file of FIG. 14, and display the image contained in IMAGE DATA-1. The TIFF reader ignores the heavy-outlined blocks 200, 210, 215, and 220, because pointers such as O2 and O3 cause the TIFF reader to skip over those heavy-outlined blocks.

The second feature is that the original, unaltered TIFF image can be available within block 210. The original TIFF image can be read directly by appropriate software, and its digital signature verified, if desired.

The only security issue lies in the trustworthiness of the party who (1) received the original TIFF image, (2) generated the multiple TIFF file of FIG. 8, and (3) interleaved data into the multiple TIFF, as partly shown in FIG. 14. Since this party will be part of the banking system, the trustworthiness is taken as granted.

The original TIFF image within block 210 can be located by pointers 205, which are contained in the private header 200. The private header 200 can contain a unique identifier, in the form of a unique character sequence, which allows the private header 200 to be located by software which scans the overall file, looking for the identifier. Once private header 200 is located, the pointers to blocks such as 210, 215, and 220 become available to retrieve those blocks.

In one embodiment, a private pointer O9 can be placed into, for example, header IFD-1, which points to the private header 200, and is used to locate the private header 200. This approach can eliminate the need of the unique identifier contained in the private header 200. It is possible to use both the private pointer 09 and the unique identifier.

Blocks 215 and 220 contain additional data, and, as stated above, more or fewer blocks can be present. Block 215 contains a digital signature for the data within block 210, which, in the immediate example, is a digital signature for the original TIFF image of a bank check. Block 220 contains a digital signature for the data of IMAGE DATA-1.

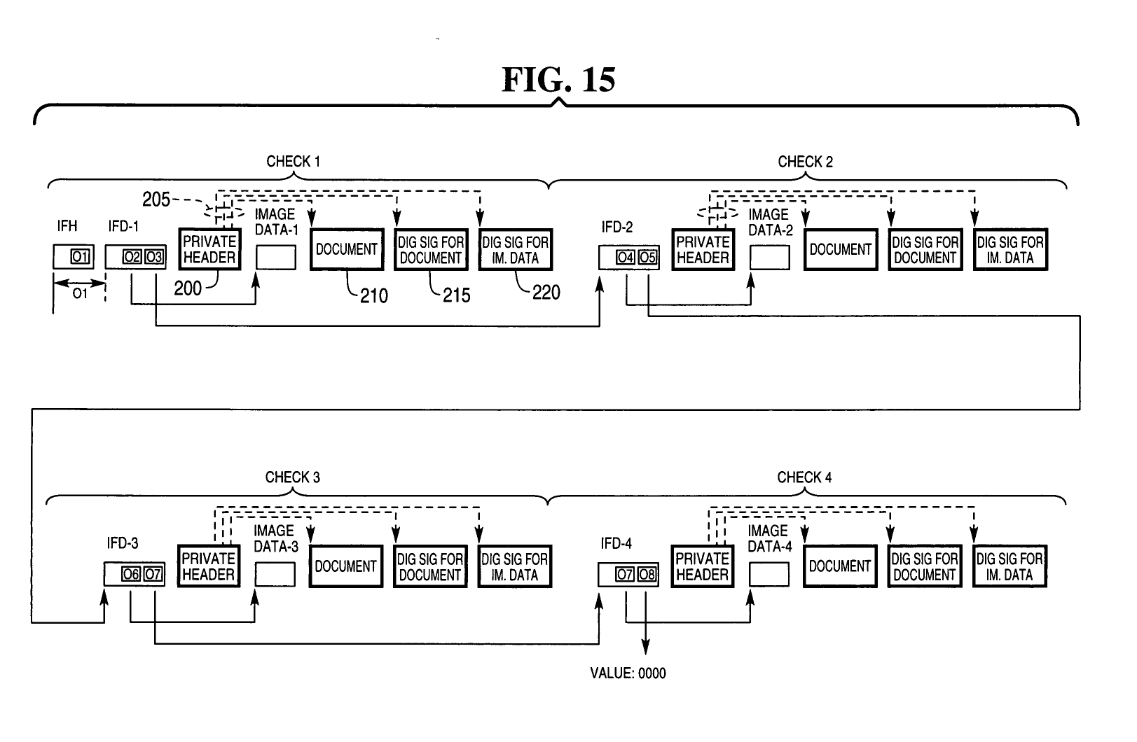

This process is repeated, if desired, for the other IMAGE DATA blocks, to produce a file having the general structure shown in FIG. 15. FIG. 15 shows four groups of data but that is merely illustrative: any number of groups can be used, and no limit is placed on the size of the file.

It is pointed out that the pointers O2, O3, etc., in FIG. 15 will, in general, be different from those of FIG. 8. For example, pointer O3 in FIG. 15 must point to a location which is a sufficient distance from IMAGE DATA-1 to allow blocks 210, 215, and 220 to reside in that distance. This requirement is not present in the situation of FIG. 8.

It is, of course, possible in the situation of FIG. 8 to create empty space between IMAGE DATA-1 and IMAGE DATA-2, at the time of creation of the composite file, to create room for additional blocks such as 210, 215, and 220, as shown in FIG. 15, to thereby accommodate the later insertion of such blocks.

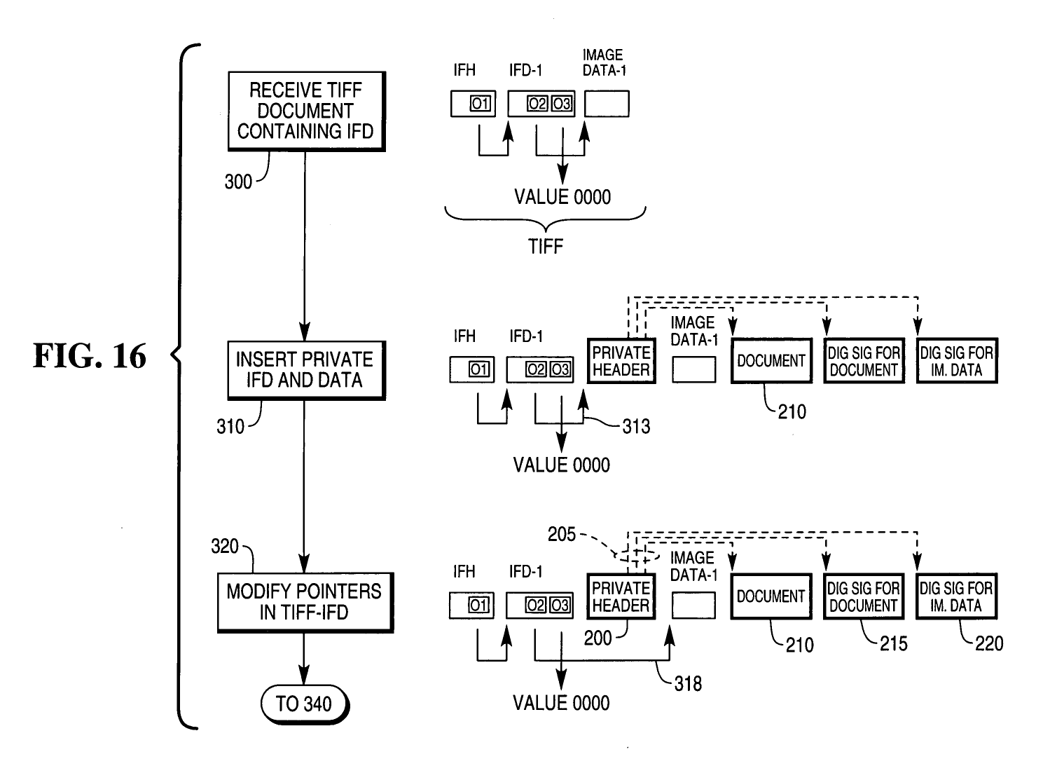

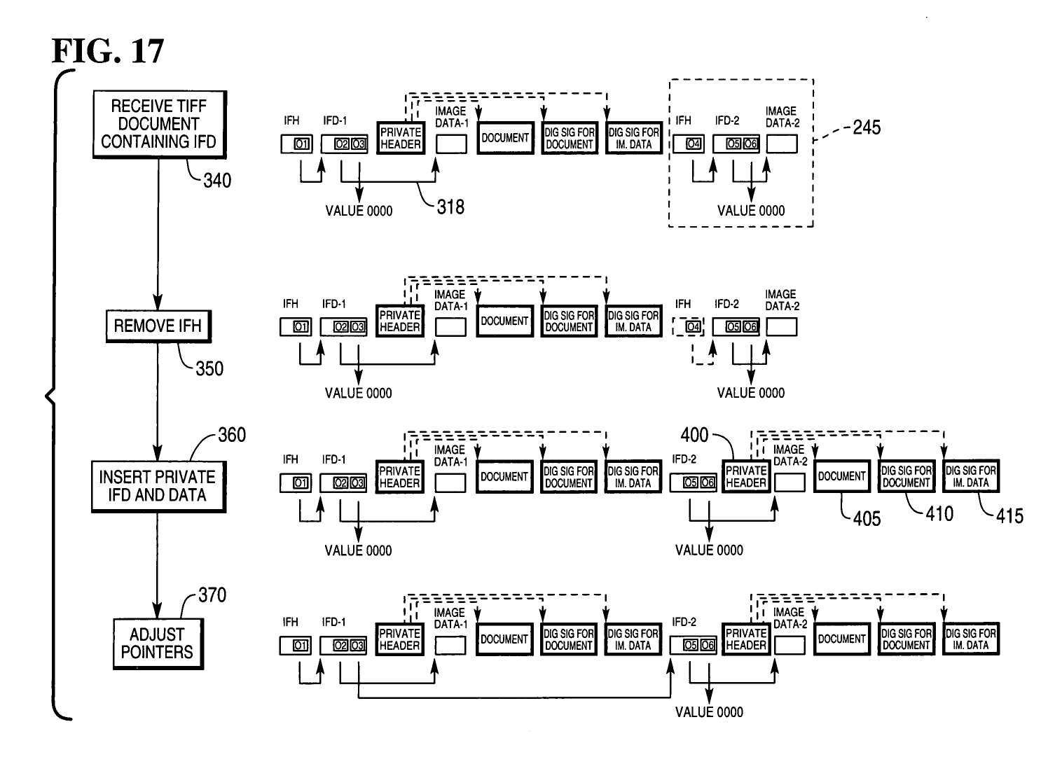

FIGS. 16 and 17 represent a flow chart of processes undertaken in one approach to generating the file of FIG. 15. In block 300 of FIG. 16, an ordinary TIFF file is received, such one of four images of a bank check, as discussed above. The image to the right of block 300 represents the TIFF file. Pointer O3 has a value of 0000, indicating that the TIFF file contains a single image.

Block 310 indicates that a private IFD and other data is interleaved into the TIFF file. The image to the right of block 310 indicates the overall file, after the interleaving. Pointer 313, which previously pointed to IMAGE DATA-1, is no longer correct at this time.

Block 320 indicates that pointers in the TIFF's IFD, as well as other pointers, are corrected. For example, the pointer O2 is corrected to accurately point to IMAGE DATA-1. As another example, it may be convenient to create pointers 205 at this time, because, until the length of IMAGE DATA-1 becomes known, the minimum required distance between block 200 and block 210 is not known, and that distance becomes available at this time.

Block 340 in FIG. 17 indicates that a second TIFF image is received, indicated as dashed block 245 in the image to the right of block 340. Block 350 indicates that the IFH, Image File Header, of the new TIFF file is removed. The removal is indicated by the phantom block surrounding the phrase “O4.” This is done because, as explained above, a single TIFF file is being created, which requires a single IFH. The IFH containing pointer O1, at the extreme left, serves as this single IFH.

Block 360 indicates that another private header and associated data is interleaved within the file. Blocks 400, 405, 410, and 415 indicate this interleaved material.

Block 370 indicates that the pointers are adjusted.

This process continues until all desired additional data is inserted into the file, thereby producing, for example, the file shown in FIG. 15.

This approach produces a file having the following important characteristics. One, it can be read and displayed by an ordinary TIFF reader, although the TIFF reader does not display the added material, indicated by the heavy blocks in FIG. 15. Two, the added material can be located by a software package which locates the private headers, such as block 200 in FIG. 15. The private headers point to the added material (e.g., block 210), and allow manipulation of the added material, as by printing, displaying, copying, etc.

The added material, in general, can take the form of any type of digital data, including without limitation word processing documents; digitized images, including biometric images such as fingerprints and photographs; encrypted data; and data which is partly redundant to that in the TIFF file, such as the original TIFF document discussed above.

### SECOND ADDITIONAL EMBODIMENT

In the Additional Embodiment discussed above, several TIFF files were concatenated into a single file, together with additional material interleaved among the TIFF files. In this Second Additional Embodiment, non-TIFF files are accepted as input, and concatenated.

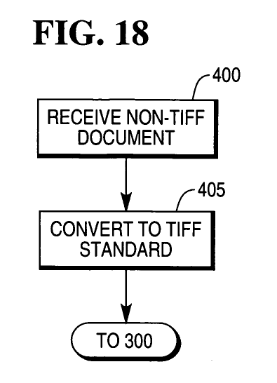

In FIG. 18, block 400 indicates that a non-TIFF original file is accepted, in digital form. The non-TIFF file can be, for example, a bitmap, text file, drawing, photograph, or any file generally. Block 405 indicates that the non-TIFF file is converted into a file conforming to the TIFF standard.

Such conversion is known in the art. As a simple example, many software applications, and some operating systems, contain routines which package documents into a format suitable for transmission to a facsimile machine. Conversion from the facsimile format into a TIFF standard is well known.

As another example, many optical scanners produce digitized images from paper documents. Software supplied with the scanners offers numerous formats in which to export the digitized images, and the TIFF format is commonly included.

After the conversion of block 405, the process beginning at block 300 in FIG. 16 begins. The TIFF headers IFH and IFD-1, shown adjacent block 300, are created at this time, if not already created in the TIFF-conversion process. Thus, at this time, the TIFF document shown adjacent block 300 is now present.

Block 310 indicates that a private IFD and other data are added to the TIFF document. In one form of the invention, the other data, indicated by document 210, takes the form of the non-TIFF original document, which was received by block 400 in FIG. 18. Thus, the original non-TIFF document, which was converted into a TIFF document, is concatenated with that TIFF document.

That is, in the image adjacent block 310, the document 210 represents the original non-TIFF document, and IMAGE DATA-1 represents the TIFF document into which the non-TIFF document was converted. This arrangement is somewhat analogous to the situation discussed above, wherein document 210 represents an original TIFF document and IMAGE DATA-1 represents the same TIFF document, but with altered pointers.

As a specific example, the non-TIFF document 210 can take the form of a paper photograph which has been digitized by an optical scanner. The IMAGE DATA-1 can take the form of a TIFF file derived from the scanned photograph.

In FIG. 18, in the image adjacent block 320, if necessary, data is created and incorporated into the private header 200. This data can include technical information about the original non-TIFF document 210 and, in principle, is of the type contained in an IFD for a TIFF document. Also, the data can include the required pointers 205.

A digital signature 215 for the non-TIFF document 210 can be generated, as can a digital signature 220 for the newly created TIFF file, represented by IMAGE DATA-1.

The added material represented by block 210 in FIG. 15 may have been created by a well-known software program, such as a standard word processor. In one form of the invention, the reader which locates the private header 200, and which then locates the interleaved material such as block 210 in FIG. 15, can (1) identify the program which generated block 210, (2) locate and launch that program, and (3) load block 210 into the program. This process allows automated display of the added material.

Additional Considerations

1. The term “digest” is a term-of-art, and refers to the subset of data extracted from a file, which is used as input to an algorithm which produces a digital signature. The subset is not precluded from including all characters in the file.

2. The term “digital signature” is a term-of-art. Digital signatures are described in the text “Applied Cryptography,” by Bruce Schneier (John Wiley & Sons, New York, 1996, ISBN 0 471 12845 7). This text is hereby incorporated by reference.

This term-of-art will be emphasized by a counter-example.

“Digital signature,” as a generic term, could be used to describe a handwritten signature which has been digitized. That is, as a generic term, as opposed to a term-of-art, it could describe a bitmap of a handwritten signature.

But, as a term-of-art, it does not describe such a bitmap.

In one usage as a term-of-art, it describes a computed result, produced by an algorithm, to which a “digest” has been applied as input.

3. The term “file,” referring to “computer file,” is a term-of-art. One definition of such a “file” is a collection of data which is processed by a computer, or its operating system, as a unit.

For example, a computer contains a microprocessor. Assume that no operating system is installed in the computer. One can order the computer to print data on a printer, by issuing to the microprocessor, for each character of the file to be printed, the proper collection of “print” commands. The microprocessor then issues its own commands to the memory location, or port, to which the printer is connected.

However, if an operating system is installed, one can specify the data to be printed by means of a file name, as opposed to issuing individual instructions for each character in the file to be printed.

Similarly, the operating system allows the data to be stored, and retrieved, based on the file name.

Thus, one characteristic of a “file” is that it can be processed in certain ways, based on its name, rather than on the individual characters within it.

Consequently, a mere collection of data is not necessarily a “file.” It can become a “file” by giving it a name, and formatting it, both in a manner usable by an operating system.

As a specific example, while a collection of stock market reports in a newspaper may constitute “data,” the collection is not necessarily a “file,” or “data file.”

One reason is that the data is not usable by an operating system. Even if the data is encoded as ASCII bytes, it still has not become a “file.” The mere collection of bytes cannot be handled by an operating system, until properly formatted and named.

4. In the examples given herein, all pointers indicate positions of items, relative to the beginning of the file, as in FIG. 7, for example. Such pointers can be called “absolute” pointers, because they all refer to a single reference, or base point.

However, the principles of the invention can still be used if the pointers use different base points. For example, pointer A can indicate the distance from the beginning of a file to item A. Pointer B can indicate the distance from the end of item A to item B, and so on. Such pointers are sometimes called “relative” pointers.

5. This Point 5 will offer definitions of some terms.

In the original TIFF files (or other type file), such as that of FIG. 7, “parameters” having “values” are present. When the TIFF files are combined into the composite file of FIG. 8, the “parameters” are still present, but the “values” may have changed. The invention allows recovery of the original “values.” Two terms can be defined, namely, “parameter” and the parameter's “value.” For example a specific tag, under the TIFF standard, can be termed a parameter.

Also, a specific location in the file can qualify as a parameter. For example, the Nth byte from the beginning can be a parameter.

The parameters are assigned values. That is, the “parameters” identify the bytes of interest in various ways, but the content of those identified bytes are the “values” of the parameters.

To repeat: a group of bytes (a parameter) can be identified by a label. For example, the label may be “TAG_53” and the bytes identified are the two bytes immediately following the label, as in

TAG_53: byte(1), byte(2)

### Or a group of bytes may be identified by convention, wherein the first N bytes in a file represent parameter 1, the next M bytes represent parameter 2, and so on.

The numerical value of each group of bytes is the “value” of the parameter.

By analogy, in a bank check, the blank “date” field is a parameter, and the handwritten contents of the field represent the value of the parameter.

From another perspective, the parameter describes the meaning of the value. For example, the number 32 can be a value, which has little meaning in itself. However, if “32” is the value of a “date” parameter, then it can refer to February 1, the 32nd day of the year.

Under the invention, parameters with their associated values are stored the TIFF files of the individual bank checks. For example, OFFSET 2, or O2, in FIG. 9 is a parameter, and the number assigned to O2 is the parameter's value.

When the TIFF files are combined into the single composite file the parameters are still present, but the values can change.

As a hypothetical example, in FIG. 9, the parameter containing the value ON tells a TIFF reader that the image data is located a certain number of bytes from the beginning of the file. The TIFF standard (or whatever standard is being used) tells the designer of the TIFF reader how to find the parameter having this value.

However, in the composite file, at the top of FIG. 9, the value of the parameter has been changed, and is now indicated as O4. The value indicates the distance from IMAGE DATA-2 to the beginning of the file, which is different, compared with the TIFF file for check 2 individually.

Therefore, in one form of the invention, an individual TIFF file contains one or more parameters, each having a value. The parameters are retained when the individual files are collected into the composite file, but the values of the parameters may change.

Since the values may change, if those changed values are included in a digest created based on the composite file, the digital signature will change.

6. TIFF files have a format which is compatible with a TIFF reader, which can read the TIFF files, and then display a graphical image of the image-data, as by printing the image, or displaying the image on a monitor.

It could be said that the format of the TIFF file is also compatible with an ordinary text editor, which can read the file and display the individual bytes, but which cannot display a graphical image of the image data. However, this latter meaning is not intended herein.

One definition of “compatible” can be derived by observing a common characteristic of all computer files, namely, that they all consist of bits, which are arranged as characters, such as bytes. However, the format of a TIFF file provides additional functionality beyond the mere presence of bytes, such as the ability to cooperate with a TIFF reader to produce a graphical image.

Similarly, an HTML document is formatted in a manner which allows an HTML reader to display the document in a way specified by the codes within the HTML document.

Similarly, a digitized music file is formatted in a manner which allows a music player to play a song. A similar comment applies to a movie file.

Thus, one definition of “compatible” is that a file is “compatible” with a program if (1) the two can cooperate to produce predetermined functionality, such as displaying an image or movie, or playing music, and (2) other files exist which cannot cooperate with the program to produce that functionality.

As a negative definition, the mere ability of a program to read data from a file does not make the file compatible with the program.

7. It is possible to characterize one form of the invention so that it superficially resembles a certain prior-art process. For example, it could be said that the invention begins with files which produce digital signatures. The files are combined into a single composite file, with modifications, so that the files no longer produce their digital signatures. The invention extracts the files from the composite file, and removes the modifications, so that the extracted files again produce the proper digital signatures.

It could be said that an ordinary compression process has these features. That is, the process of (1) combining files into a single file and (2) compressing the single file causes the individual files to fail to produce their digital signatures. Then, if the single file is de-compressed, and the individual files are recovered, they will now correctly produce their digital signatures.

However, one distinction between this process and one form of the invention is that the compressed file is not usable by a program with which the files are “compatible.” For example, a TIFF reader cannot read the compressed file.

Also, under the invention, when a TIFF file is placed into the composite file, some content of the TIFF file is modified. In general, that does not occur in the compression process. That is, the compression process is designed not to modify content. The compression process modifies the symbols representing content, but does not modify the content itself.

As a simple example, a compression algorithm may process data in units of 100 characters. If a given set of 100 characters begins with “W,” is followed by 98 zeroes, and then ends with another “W,” (i.e., W00000000 . . . 00000W) the compression algorithm may represent those 100 characters as

W-0(98)-W

which means 98 zeroes with “W” at both ends. The “content” (98 zeroes with “W” at both ends) has not been changed, but the symbols representing the content have been changed.

8. The discussion above has focused on TIFF files. However, the invention is applicable to computer files generally, which are collected into a single composite file.

9. Four sub-files can be extracted from the composite file of FIG. 8, with a copy of the IFH being used for each sub-file. Digital signatures can be generated for each of the sub-files. Digital signatures can be generated for each of the sub-files, but as-present in the composite file.

If this were done, then the same digital signatures would be obtained from the sub-files, after extraction, compared with the sub-files, as present in the composite file.

However, these sub-files, after extraction, are not compatible with a TIFF reader, for reasons described herein.

10. It was stated above that four images were generated of a check: two images of the check as it appeared on arrival, and two images of the check after any alterations.

Another reason for generating multiple images lies in error correction techniques. One set of images can be generated in a black/white format, and another set generated in grayscale format. The two sets of images allow recovery of content which may have been lost in the digitizing process.

11. One specific embodiment contemplates insertion of individual TIFF files, containing images of bank checks as discussed herein, into a composite file. As a specific example, images of all bank checks drawn on a given account in one month, or other accounting period, are combined into the composite file.

Other documents, associated with the bank checks, are interleaved within the composite file. For example, the other documents may include the bank statement for the one-month period identified above.

In one form of the invention, the checks are readable by a TIFF viewer, but the other documents are not.

More generally, the invention contemplates combining TIFF documents into a multi-image TIFF file, for reading by a TIFF viewer, and the addition of other documents, which are not readable by the TIFF viewer, but which are located and manipulated using the private headers, such as header 200 in FIG. 16.

In the example given above, it is preferable that only a single copy of the bank statement be inserted into the composite file. That is, a copy of the bank statement is not concatenated with each bank check, but only a single copy is interleaved within the composite file.

12. In one form of the invention, a difference structure of the type shown in FIGS. 11 and 12 is generated for the file of FIG. 15, to allow recovery of the original TIFF files. This allows usage of the digital signatures, as described herein.

13. FIG. 15 shows blocks 200, 210, 215, and 220 positioned at specific locations. However, in general, these blocks can be located anywhere within the overall file, although it may be more convenient to position them near to the TIFF file to which they relate.

14. FIG. 18 refers to conversion of a non-TIFF file into a TIFF file. If the non-TIFF file contains a bitmap, the technical details of the bitmap will, in general, be standardized. For example, the pixels can be monochrome, grey-scaled, or colored. If monochrome, each pixel can be represented by a single bit. If grey-scaled, each pixel can be represented by a specific number of bits, such as eight bits. If colored, several standard encodings for the pixels are available, such as RGB (Red, Green, Blue), CMYK (Cyan, Magenta, Yellow, Black), and others.

For most, if not all, non-TIFF files, these characteristics and others (e.g., size of pixels, size of image in pixels, type of encryption) will possess values within known ranges. Therefore, in many, if not all, expected cases, the conversion into TIFF format will simply involve identifying the relevant variables, and specifying them in the TIFF headers (e.g., IFH and IFD). The original bitmap can be used without alteration.

15. In one form of the invention, additional data is interleaved within a multi-page (or multi-view) TIFF file. The data contains information which is not related to functional aspects of the file. For example, computer files can contain data which, in essence, server a formatting function, such as an end-of-file (EOF) marker. The EOF marker serves a formatting function, by indicating the end of the file.

As another example of functional aspects, the individual contents of the TIFF file need not be adjacent. For instance, in FIG. 16, the TIFF file at the top may contain space between the IFH and IFD-1. That space may be filled with padding characters. Even though the padding characters may, in some sense, be termed data, those characters serve a function related to the functionality of the file. They do not provide information to a third party.

Therefore, under the invention, the data which is interleaved within the file contains information usable by third parties. The pointers to that data are used to find the data.

16. In one form of the invention, data which is interleaved within a multi-page TIFF file includes content which is identical to some content of the TIFF file. For example, one page of the TIFF file may include a bitmap of one side of a bank check as it arrives for processing. However, as explained herein, the pointers in that page may be different from the pointers within the original TIFF file, generated from the bank check.

The original bitmap of the bank check may be interleaved within the TIFF file. That bitmap may be a TIFF file, and contain the original pointers. However, this original bitmap will not be displayed by a TIFF reader, at least for the reason that the IFDs in FIG. 17 will not point to it. And the original bitmap will contain content which is identical to some content of the corresponding page within the TIFF file, such as the bitmap itself.

Numerous substitutions and modifications can be undertaken without departing from the true spirit and scope of the invention. What is desired to be secured by Letters Patent is the invention as defined in the following claims.

What is claimed is:

1. A method, comprising:
a) receiving multiple TIFF images, each of a bank check, and auxiliary information;
b) generating a TIFF file, which contains
i) the TIFF images, which a TIFF reader will display; and
ii) the auxiliary information, which the TIFF reader does not display.

2. Method according to claim 1, and further comprising:
c) inserting one or more private headers into the TIFF file which point to the auxiliary information.

3. Method according to claim 1, wherein the auxiliary information does not affect functionality of the TIFF file or the TIFF reader.

4. Method according to claim 1, wherein the TIFF images comprise digitized bank checks.

5. Method according to claim 4, wherein the auxiliary information comprises financial information about a person owning an account on which the bank checks are drawn.

6. Method according to claim 4, wherein the auxiliary information comprises a bank statement which refers to at least one of the bank checks.

7. Method according to claim 3, wherein the auxiliary information comprises a bitmap of one of the bank checks.

8. Method according to claim 1, and further comprising:
c) using a program, different from a TIFF reader, to read the auxiliary information.

9. Apparatus, comprising:
a) a computer-readable storage medium;
b) stored within the storage medium,
i) a multi-page TIFF file, containing images of bank checks, which contains pages which a TIFF reader will display; and
ii) auxiliary information, interleaved within the TIFF file, which the TIFF reader does not display.

10. Apparatus according to claim 9, and further comprising:
c) one or more private headers in the TIFF file which point to the auxiliary information.

11. Method according to claim 9, wherein the auxiliary information does not affect functionality of the TIFF file or the TIFF reader.

12. Method according to claim 9, wherein the TIFF images comprise digitized bank checks.

13. Method according to claim 12, wherein the auxiliary information comprises financial information about a person owning an account on which the bank checks are drawn.

14. Method according to claim 12, wherein the auxiliary information comprises a bank statement which refers to at least one of the bank checks.

15. Method according to claim 11, wherein the auxiliary information comprises a bitmap of one of the bank checks.

16. A method, comprising:
a) accepting multiple TIFF images of a single bank check;
b) combining the multiple TIFF images into a single file, wherein a header is present for each TIFF image, which header allows a TIFF reader to locate and display each TIFF image; and
c) inserting a digital signature into the file, which
i) does not interfere with the TIFF reader, and
ii) is not displayed by the TIFF reader.

17. Method according to claim 16, and further comprising:
d) using a program, different from a TIFF reader, to read the non-TIFF data.

18. Apparatus, comprising:
a) a computer readable storage medium;
b) a multi-page TIFF file contained within the storage medium, which contains information which a TIFF reader can display; and
c) data interleaved within the TIFF file, which the TIFF reader does not display, which data comprises a digital signature.

19. Apparatus according to claim 18, wherein the data includes some content which is identical to content of a page in the TIFF file.
